(19) United States
(12) Patent Application Publication
(10) Pub. No.: US 2014/0138934 A1
(43) Pub. Date: May 22, 2014

(54) PUSH BAR ASSEMBLY FOR A VEHICLE

(71) Applicant: Caterpillar Paving Products Inc., Brooklyn Park, MN (US)

(72) Inventors: Derek K. Huhn, Monticello, MN (US); Jacob M. Saari, Otsego, MN (US); Jason S. Moe, St. Louis Park, MN (US); Kenneth G. Jones, Buffalo, MN (US)

(73) Assignee: Caterpillar Paving Products Inc., Brooklyn Park, MN (US)

(21) Appl. No.: 14/165,693

(22) Filed: Jan. 28, 2014

(51) Int. Cl. B60D 3/00

(52) U.S. Cl. CPC B60D 3/00
USPC 280/481

(57) ABSTRACT

A push bar assembly for an operating vehicle is provided. The push bar assembly includes a telescopic bar, a tow eye, a hitch assembly, and a spring assembly. The telescopic bar includes a first tube, a second tube and a spring-lock pin. The second tube is configured to move inside the first tube. The spring-lock pin is mounted on the first tube and configured to restrict the telescopic motion of the second tube inside the first tube. The hitch assembly includes a first end, a second end and an eye. The hitch assembly is configured to couple the telescopic bar with the operating vehicle. The tow eye is coupled to a second end of the second tube. Further, the spring assembly is mounted on the first tube and is coupled to the hitch assembly.

### TECHNICAL FIELD

The present disclosure generally relates to a vehicle. More specifically, the present disclosure relates to a push bar assembly for the vehicle.

### BACKGROUND

A push bar assembly is generally used to connect an operating vehicle to a vehicle to be pushed or pulled. Numerous push bar assemblies have been created to connect an operating vehicle to the vehicle to be pushed or pulled.

Typically, a push bar assembly includes a single bar structure. The push bar assembly may be coupled to the operating vehicle and the vehicle to be pushed or pulled. The push bar assembly is designed such that there is limited motion between the operating vehicle and the vehicle to be pushed or pulled. The limited motion leads to tremendous stresses on the push bar assembly. The stress may result in the failure of the push bar assembly. This may result in the possible damage or destruction of the vehicle to be pushed or pulled, and may also result in damage of property present in the vicinity of the vehicle. In some cases, the push bar assembly needs to be decoupled from both the operating vehicle and the vehicle to be pushed or pulled, once the associated operation is over. In other cases, the push bar assembly needs to be decoupled from the vehicle to be pushed or pulled and may be stowed and locked in a place on the operating vehicle. The coupling and decoupling of the push bar assembly along with the movement required to stow the push bar assembly may require an effort from an operator.

The present disclosure is directed to solve one or more problems associated with earth moving machines as cited above.

### SUMMARY

In an embodiment, a push bar assembly for an operating vehicle is provided. The push bar assembly comprises a telescopic bar, a hitch assembly, a spring assembly and a tow eye. The telescopic bar further comprises a first tube, a second tube, and a spring-lock pin. Both the first tube and the second tube include a first end and a second end. The second tube is configured to telescopically move inside the first tube. A spring-lock pin is mounted on the first tube. The spring-lock pin is mounted in proximity of the second end of the first tube. The spring-lock pin is configured to restrict the motion of the second tube inside the first tube. A tow eye is coupled to the second end of the second tube. The push bar assembly further includes a hitch assembly having a first end, a second end and an eye. The first end of the hitch assembly is coupled to the operating vehicle. The second end of the hitch assembly is coupled to the telescopic bar. Further, the hitch assembly is configured to pivot corresponding to the operating vehicle about a first axis and the telescopic bar is configured to pivot corresponding to the hitch assembly about a second axis. The first axis and the second axis are substantially perpendicular to each other. A spring assembly is mounted on the first tube of the telescopic bar. The spring assembly further includes a connecting rod, a stopper, a spring, and a housing. The connecting rod further includes a first end and a second end. The first end of the connecting rod is pivotally coupled to the eye of the hitch assembly. The stopper is coupled to the second end of the connecting rod. The spring wound around the connecting rod. Further, the spring is disposed inside the housing between the stopper and the end cap. The operating vehicle discussed in the above embodiment can be a rotary mixer.

Other features and advantages of the disclosure will become apparent to those skilled in the art, upon review of the following detailed description and drawings.

### BRIEF DESCRIPTION OF THE DRAWINGS

FIG. 1 is a side view of an operating vehicle, in accordance with the concepts of the present disclosure;

FIG. 2 illustrates a push bar assembly, in accordance with the concepts of the present disclosure;

FIG. 3 is an enlarged view of a tow eye for the push bar assembly, in accordance with the concepts of the present disclosure;

FIG. 4 is an illustrative view of a hitch assembly for the push bar assembly ,in accordance with the concepts of the present disclosure;

FIG. 5 is an exploded view of a spring assembly, in accordance with the concepts of the present disclosure;

FIG. 6 is an enlarged view of the latch assembly, in accordance with the concepts of the present disclosure; and

FIG. 7 is an illustrative view of a push bar assembly in a storage position, in accordance with an embodiment of the present disclosure.

### DETAILED DESCRIPTION

Detailed embodiments of the present disclosure are described herein with reference to the following figures. The specific structural and functional details disclosed herein are intended to be exemplary and should not be interpreted as limiting the disclosure.

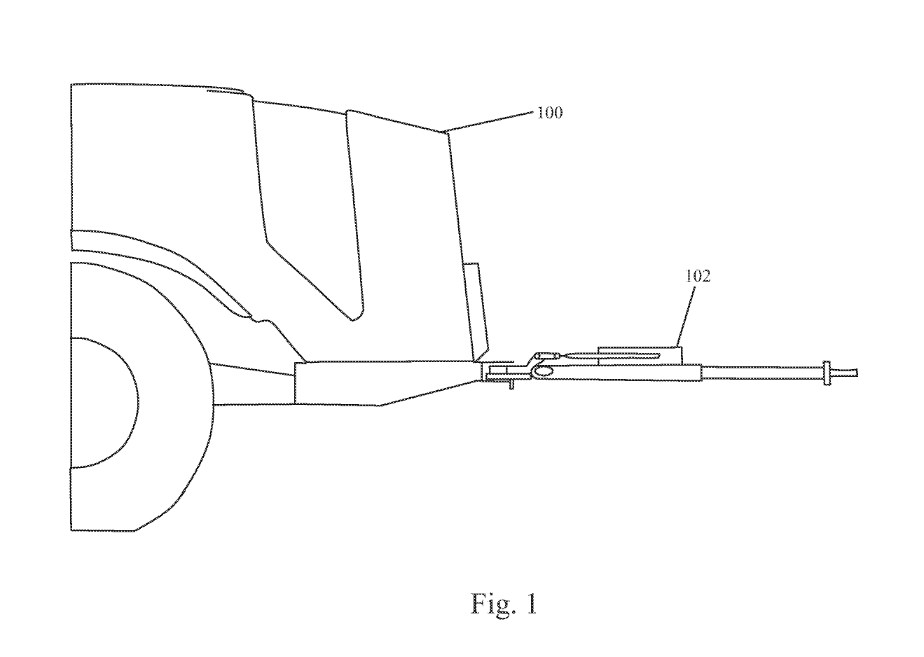

FIG. 1 is a side view of an operating vehicle 100, in accordance with the concepts of the present disclosure. Operating vehicle 100 may comprise a push bar assembly 102. In an embodiment, the operating vehicle 100 may be a rotary mixer. The push bar assembly 102 may be used to push or pull a second vehicle such as a water truck.

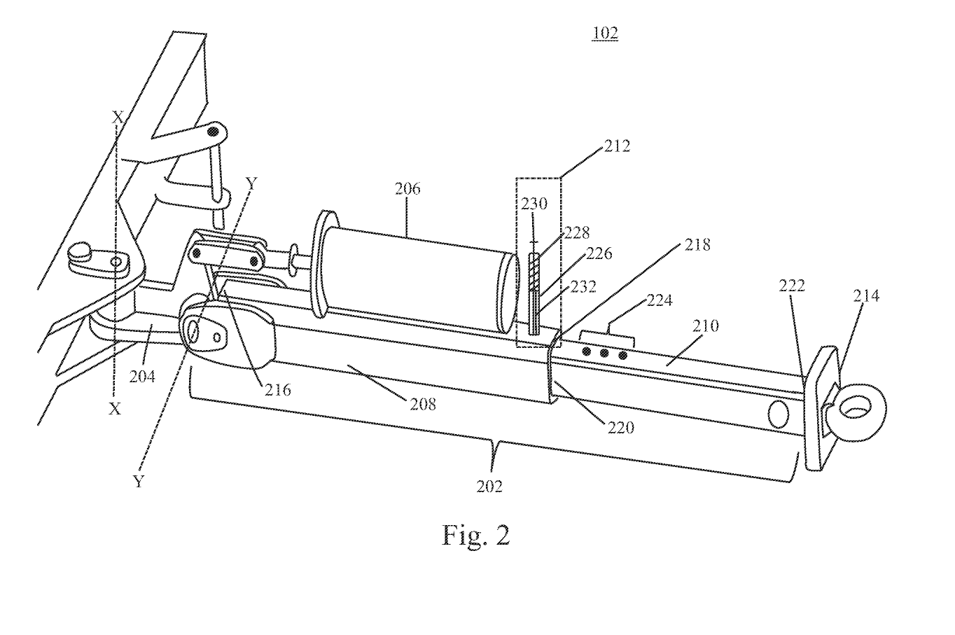

FIG. 2 illustrates a push bar assembly 102 for an operating vehicle 100, in accordance with the concepts of the present disclosure. The push bar assembly 102 may include a telescopic bar 202, a hitch assembly 204, and a spring assembly 206. The telescopic bar 202 further includes a first tube 208, a second tube 210, a spring-lock pin assembly 212, and a tow eye 214.

The first tube 208 of the telescopic bar 202 may be a hollow tube structure configured to act as an outer tube for the telescopic bar 202. The first tube 208 may include a first end 216 and a second end 218. The first tube 208 may be of, but not limited to, a circular, a rectangular cross-section. The first tube 208 may be of a uniform cross-section throughout the length. However, it will be evident to a person with ordinary skills in the art that any characteristic associated with the cross-section of the first tube 208, does not limit the idea disclosed. The first tube 208 may further be configured to house the second tube 210.

The second tube 210 may act as an inner tube for the telescopic bar 202. The second tube 210 may be a hollow tube structure. The second tube 210 may include a first end 220, a second end 222, and a plurality of holes 224. In an embodiment, the second tube 210 may have a circular or the rectangular cross-section similar to the cross-section of the first tube 208. The second tube 210 may be of uniform cross-section throughout the length. The second tube 210 is configured to move or slide inside the first tube 208. In an extended position, the second tube 210 may extend out from the first tube 208. In a refracted position, the second tube 210 may be present fully inside the first tube 208. In an embodiment, the length of the second tube 210 is larger than the length of the first tube 208. The second tube 210 may be locked with the first tube 208 by the spring-lock pin assembly 212. In other words, the telescopic motion of the second tube 210 within the first tube 208 is restricted by the spring-lock pin assembly 212.

The spring-lock pin assembly 212 may be mounted on the first tube 208 in proximity to the second end 218. The spring-lock pin assembly 212 may include a housing 226, a spring 228, a plunger 230 and a pin 232. The housing 226 may be a hollow structure configured to support the other members of the spring-lock pin assembly 212. The spring 228 is placed inside the housing 226. The plunger 230 may be coupled with the pin 232 at one end. The other end of the plunger 230 protrudes above the housing 226. The protruding end of the plunger 230 may be operated by an operator to move the pin 232 out of the plurality of holes 224 of the second tube 210. The pin 232 may be configured to compress the spring 228 when the plunger 230 is pulled by the operator. The pin 232 may pass through a through hole (not shown in figures) in the first tube 208. The pin 232 may further engage with one of the plurality of holes 224, which may be present on the second tube 210, in proximity to the first end 220. This configuration may lock the movement of the second tube 210 with in the first tube 208. The second tube 210 may be telescopically moved in/out of the first tube 208, when the plunger 230 is pulled to disengage the pin 232 from the second tube 210. This allows the second tube 210 to move within the first tube 208.

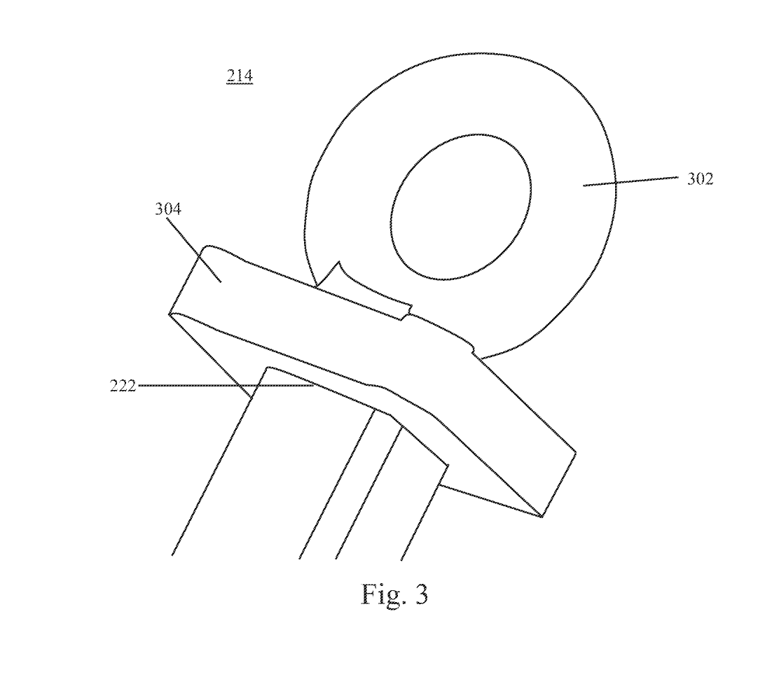

In an embodiment, the second end 222 of the second tube 210 may be coupled to the tow eye 214. The tow eye 214 may be configured to couple the push bar assembly 102 with another vehicle which may be pushed or pulled. An enlarged view of the tow eye 214 is shown in FIG. 3. As illustrated in FIG. 3, the tow eye 214 includes a ring element 302 and a plate element 304. The ring element 302 may be configured to engage with another vehicle required to be pushed or pulled. The plate element 304 may be coupled to the second end 222 of the second tube 210 by welding, bolting or any other coupling method known in the art. In an embodiment, the tow eye 214 may be an integral part of the second tube 210. However, it may be appreciated that any other mechanism known in the art can be used to couple the push bar assembly 102 with the second vehicle. For example, a U-hook, a knuckle joint, a quick coupler may be used to couple the push bar assembly 102 with the second vehicle.

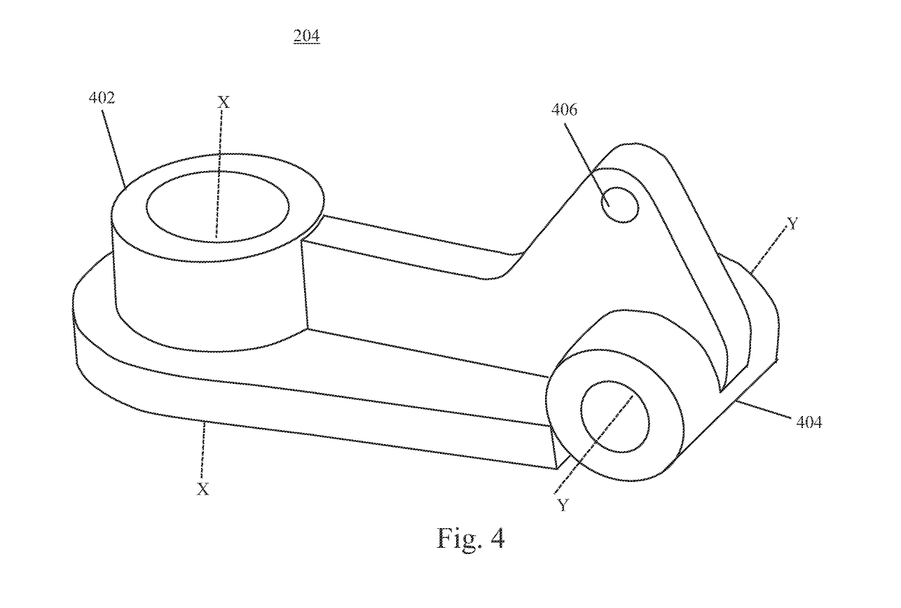

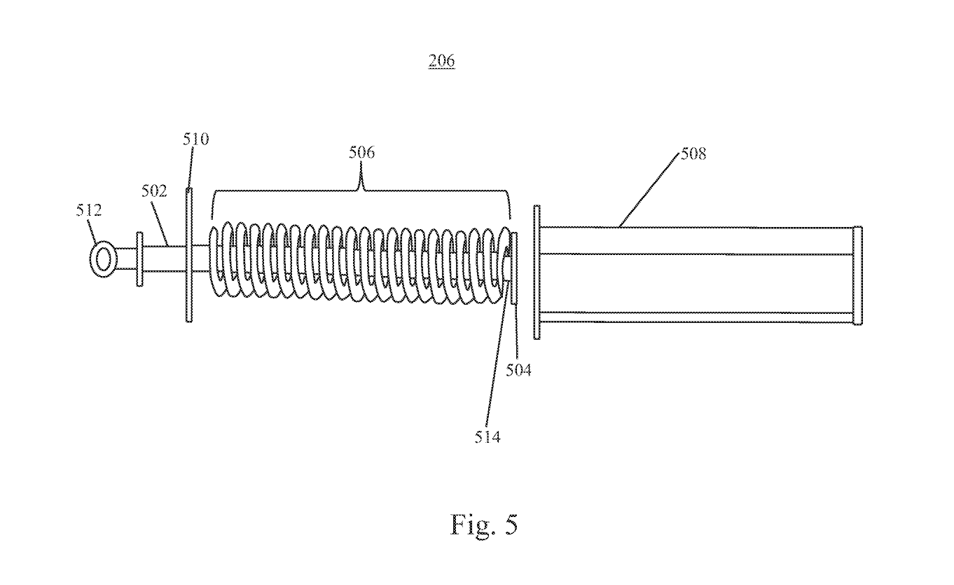

The telescopic bar 202 may be coupled with the operating vehicle 100 by a hitch assembly 204. As shown in FIG. 4 the hitch assembly 204 may include a first end 402, a second end 404 and an eye 406. The hitch assembly 204 may be pivotally coupled to the operating vehicle 100 at the first end 402 such that the hitch assembly 204 may pivot about a first axis X-X. Further, the hitch assembly 204 may be coupled with the telescopic bar 202 at the second end 404 such that the telescopic bar 202 may pivot about a second axis Y-Y. The telescopic bar 202 is coupled with the hitch assembly 204 by coupling the first end 216 of the first tube 208 with the second end 404 of the hitch assembly 204. The first axis X-X is substantially perpendicular to the second axis Y-Y. In other words, yaw of the telescopic bar 202 can be adjusted by pivoting the hitch assembly 204 about the first axis X-X and the pitch of the telescopic bar 202 can be adjusted by pivoting the telescopic bar 202 about the second axis Y-Y at the second end 404 of the hitch assembly 204. The eye 406 is a protruding element with a hole on the hitch assembly 204. The eye 406 is configured to provide a pivoting point or an anchor for the spring assembly 206, as described subsequently in FIG. 5.

The hitch assembly 204 may further be coupled to the spring assembly 206. The spring assembly 206 may be mounted on the first tube 208 of the telescopic bar 202. The spring assembly 206 may be configured to assist the telescopic bar 202 in vertically upward and downward movement about the second axis Y-Y. As shown in FIG. 5 the spring assembly 206 may include a connecting rod 502, a stopper 504, a spring 506, a housing 508, and an end cap 510. The connecting rod 502 may include a first end 512 and a second end 514. The first end 512 of the connecting rod 502 is pivotally coupled or anchored to the hitch assembly 204 at the eye 406. The second end 514 may be coupled with the stopper 504. The spring 506 is disposed inside the housing 508 between the stopper 504 and the end cap 510 of the housing 508. The spring 506 is configured to wound around the connecting rod 502. The spring assembly 206 provides biasing force to provide smooth movement of the telescopic bar 202, when the telescopic bar 202 moves about the second axis Y-Y in clockwise or anti-clockwise direction.

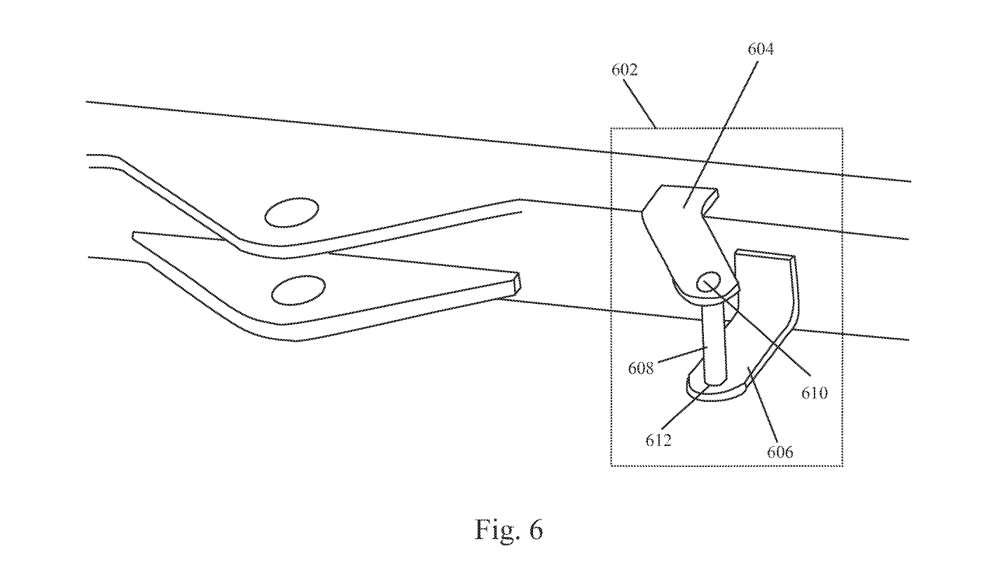

FIG. 6 is an enlarged view of the latch assembly 602, in accordance with the concepts of the present disclosure. The latch assembly 602 may be mounted on the operating vehicle 100.

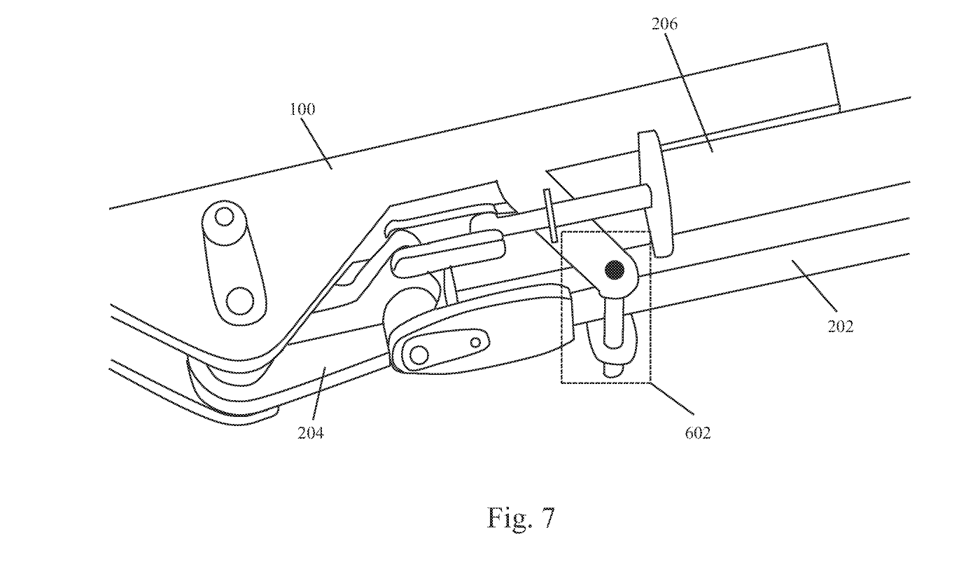

The latch assembly 602 may be configured to store the push bar assembly 102 when not in use. In an embodiment, the latch assembly 602 may include a first bracket 604, a second bracket 606 and a pin 608. The first bracket 604 includes a through hole 610 and the second bracket 606 include a through hole 612. The first bracket 604 and the second bracket 606 are mounted on the operating vehicle 100 in manner so as to provide a gap within. The telescopic bar 202 may be positioned within the gap between the first bracket 604 and the second bracket 606 in the storage position. The pin 608 may then be inserted into the through hole 610 of the first bracket 604 and the through hole 612 of the second bracket 606 to secure the push bar assembly 102 in the storage position (as shown in FIG. 7). However, it may be appreciated that any other mechanism known in the art can be used to store the push bar assembly 102 with the second vehicle. For example, a U shaped bracket, a spring loaded latch may be used to store the push bar assembly 102 in the storage position.

### INDUSTRIAL APPLICABILITY

The present disclosure provides a push bar assembly 102, which generally relates to a mechanical device used to push or pull a second vehicle with an operating vehicle 100. The present disclosure finds specific applicability to enable the second vehicle to recover when stuck in sand, mud, snow, ice or any other soft and slippery track material or in general towing of the second vehicle.

The push bar assembly 102 may be required to be light weight, compact and easy to operate and store. The push bar assembly 102 may comprise the telescopic bar 202 with the first tube 208 and the second tube 210. The second tube 210 of the telescopic bar 202 may be configured to move inside the first tube 208. The first tube 208 may further comprise the spring-lock pin assembly 212, which may be configured to lock the telescopic motion of the second tube 210, inside the first tube 208. The push bar assembly 102, may further comprise the tow eye 214 coupled to the second tube 210 of the telescopic bar 202. The tow eye 214 may be configured to couple the push bar assembly 102 to the second vehicle required to be pushed or pulled. The push bar assembly 102 may be coupled to the operating vehicle 100, with use of the hitch assembly 204. The hitch assembly 204 also enables the push bar assembly 102 to pitch as well as yaw movement. A spring assembly 206 may be mounted on the first tube 208 of the telescopic bar 202 and may be pivotally coupled to the hitch assembly 204. The spring assembly 206 may be configured to assist the push bar assembly 102 during its movement in the vertical plane or pitch movement. The push bar assembly 102 may also include a latch assembly 602 mounted on the operating vehicle 100, configured to store the push bar assembly 102.

The disclosure provides a light-weight and compact push bar assembly 102. The push bar assembly 102 contains an efficient storage location and operational characteristics. The spring assembly 206 assists in the vertical movement of the push bar assembly 102 and minimizes the efforts required for an operation. The telescopic bar 202 may allow the push bar assembly 102 to extract and retract, thus, reducing the overall size for storage. The telescopic bar 202 may also allow for easier operation while coupling the push bar assembly 102 to the second vehicle. In an exemplary embodiment, the second vehicle required to be pushed or pulled is a water truck and the operating vehicle 100, which pushes or pulls the water truck, may be a rotary mixer. The water truck may be coupled to the push bar assembly 102, mounted on the rotary mixer. The water truck can back up to the approximate location and then the push bar assembly 102 maybe extend out to the water truck. The water truck may then pull forward slowly and the spring-lock pin assembly 212 will fall into place, thus creating a rigid link connection between the water truck and the rotary mixer.

It should be understood that the above description is intended for illustrative purposes only and is not intended to limit the scope of the present disclosure in any way. Thus, those skilled in the art will appreciate that other aspects of the disclosure can be obtained from a study of the drawings, the disclosure, and the appended claim.

What is claimed is:

1. A push bar assembly for an operating vehicle comprising:
a telescopic bar comprising:
a first tube with a first end and a second end;
a second tube with a first end and a second end and configured to telescopically move inside the first tube; and
a spring-lock pin mounted on the first tube, the spring-lock pin is configured to restrict a telescopic motion of the second tube inside the first tube;
a hitch assembly comprising
a first end coupled to the operating vehicle;
a second end coupled to the telescopic bar; and
an eye;
wherein the hitch assembly is configured to pivot corresponding to the operating vehicle about a first axis and the telescopic bar is configured to pivot corresponding to the hitch assembly about a second axis wherein the first axis is substantially perpendicular to the second axis;
a spring assembly mounted on the first tube of the telescopic bar, the spring assembly comprising
a housing;
an end cap of the housing;
a connecting rod having a first end and a second end, wherein the first end of the connecting rod is coupled to the eye of the hitch assembly;
a stopper coupled to the second end of the connecting rod; and
a spring wound around the connecting rod and disposed inside the housing between the stopper and the end cap; and
a tow eye coupled to the second end of the second tube.

2. The operating vehicle of claim 1, wherein the operating vehicle is a rotary mixer.
